(19) United States
(12) Patent Application Publication
(10) Pub. No.: US 2014/0183093 A1
(43) Pub. Date: Jul. 3, 2014

(54) ULTRALIGHT FLOWABLE MATERIALS AND ARTICLES OF MANUFACTURE INCLUDING SAME

(71) Applicant: EdiZONE, LLC, Alpine, UT (US)

(72) Inventors: Tony M. Pearce, Alpine, UT (US); Joseph T. Nilson, Alpine, UT (US)

(73) Assignee: EdiZONE, LLC, Alpine, UT (US)

(21) Appl. No.: 14/145,737

(22) Filed: Dec. 31, 2013

Related U.S. Application Data
(60) Provisional application No. 61/848,392, filed on Jan. 2, 2013.

(51) Int. Cl. C08L 23/02; B65D 85/72; C08K 5/01

(52) U.S. Cl. CPC C08L 23/02; C08K 5/01; B65D 85/72
USPC 206/525; 521/56; 521/60

(57) ABSTRACT

An ultralight flowable material comprises a plurality of macrospheres having an average diameter of about 150 microns or above, and a lubricant. An amount of the lubricant in the ultralight flowable material is sufficient to substantially coat the exterior surfaces of essentially all macrospheres, but less than an amount to cause dispersion of the macrospheres in the lubricant. An article of manufacture includes a flexible container and an ultralight flowable material contained within the flexible container. The ultralight flowable material may comprise a plurality of spherical objects and a tacky lubricant in an amount to substantially coat the exterior surfaces of essentially all spherical objects but less than an amount to cause dispersion of the spherical objects in the tacky lubricant. The spherical objects comprise macrospheres, microspheres, or a combination thereof.

### CROSS-REFERENCE TO RELATED APPLICATIONS

This application claims the benefit of U.S. Provisional Patent Application Ser. No. 61/848,392, filed Jan. 2, 2013, titled “Ultra-Light Flowable Medium,” the disclosure of which is hereby incorporated herein in its entirety by this reference.

### FIELD

Embodiments of the present disclosure relate generally to ultralight flowable materials and to articles of manufacture, such as cushions and paddings, including such ultralight flowable materials.

### BACKGROUND

It has been difficult to achieve cushions or paddings for contact with a patient's skin that have some or all of the following characteristics: (i) equalization of pressure across the entire area of skin contacted to prevent damage to skin and underlying tissue, (ii) good flowability, (iii) low shearing force threshold, (iv) minimal or no memory, and (v) light weight. Additionally, it has been challenging to obtain flowable materials for cushions and paddings that have some or all of the following characteristics: (a) low specific gravity (i.e., lighter weight), (b) low thermal mass, (c) low coefficient of heat transfer, (d) minimal or no substantial change in performance with change in temperature, and (e) minimal or no separation into their constituent components over time.

Cushions and paddings that include flowable media contained within a flexible bladder has been used to offer more uniform force or pressure in contact with a patient's body than conventional cushions and paddings such as foam or springs.

For example, U.S. Pat. No. 5,421,874, which issued Jun. 6, 1995; U.S. Pat. No. 5,549,743, which issued Aug. 27, 1996; U.S. Pat. No. 5,626,657, which issued May 6, 1997; U.S. Pat. No. 6,020,055, which issued Feb. 1, 2000; and U.S. Pat. No. 6,197,099, which issued Mar. 6, 2001 (each is issued to Pearce and incorporated herein by reference) disclose flowable composite materials having low specific gravity, low thermal mass and low coefficient of heat transfer. The flowable composite materials comprise a plurality of microspheres mixed with a quantity of a lubricant sufficient to substantially coat the exterior surface of essentially all of the microspheres, but insufficient to cause dispersion of the microspheres in the lubricant. These flowable composite materials associate with the products that are licensed or sold commercially under the names FLOAM™ and Z-FLO™ by EdiZONE, LLC of Alpine, Utah. These flowable composite materials are collectively referred to hereinafter as “FLOAM™ material.” The specific gravity of commercially available FLOAM is typically about 0.28.

U.S. Provisional Application Ser. No. 61/400,829, which filed on Aug. 3, 2010 and its associated U.S. Patent Application, Publication No. 2012/0031800, which filed on Apr. 29, 2011 and published on Feb. 9, 2012 (each of which is fully incorporated herein in its entirety by this reference) disclose gel putty materials that offer enhanced comfort, in addition to low specific gravity, low thermal mass and low coefficient of heat transfer. The gel putty materials comprise an elastomeric polymer and a plasticizer, wherein a ratio of the plasticizer to the elastomeric polymer by weight is from about 1:1 to about 50:1. The elastomeric polymers have a melt mass-flow rate of from about 2 g/10 min to about 100 g/10 min. These gel putty materials associate with the products that are offered for license or sold commercially under the name FLOWZ™ by EdiZONE, LLC of Alpine, Utah. These gel putty materials are collectively referred to hereinafter as “FLOWZ™ material.” The specific gravity of commercially available FLOWZ™ material is typically about 0.22.

The specific gravities of commercially available FLOAM™ and FLOWZ™ materials are significantly lower than that of gelatinous elastomer materials commonly used in cushion devices, which is about 0.6 to 1.2. However, the specific gravities of the FLOAM™ and FLOWZ™ materials are still almost up to six (6) times higher than that of foams commonly used in cushion devices, which is only about 0.03 to 0.10. The higher specific gravities of the FLOAM™ and FLOWZ™ materials lead to heavier cushion devices compared to conventional foam cushion devices. Therefore, the commercial feasibility of using the FLOAM™ and FLOWZ™ materials in many cushion devices has been limited due to their heavier weights.

### BRIEF SUMMARY

In some embodiments, the present disclosure includes an ultralight flowable material comprising a plurality of macrospheres and a lubricant. The macrospheres have an average diameter of about 150 microns or above. The amount of lubricant in the ultralight flowable material is sufficient to substantially coat the exterior surface of essentially all of the macrospheres, but insufficient to cause dispersion of the macrospheres in the lubricant.

In other embodiments, the present disclosure includes an ultralight flowable material comprising a plurality of spherical objects and a tacky lubricant. The spherical objects comprise microspheres, macrospheres, or a combination thereof. The amount of tacky lubricant in the ultralight flowable material is sufficient to substantially coat the exterior surfaces of essentially all spherical objects, but less than an amount to cause dispersion of the spherical objects in the tacky lubricant.

In further embodiments, the present disclosure includes an article of manufacture comprising a flexible container and the disclosed ultralight flowable material contained within the flexible container.

The present disclosure also includes methods of making and using such ultralight flowable materials and articles of manufacture including such ultralight flowable material.

### BRIEF DESCRIPTION OF THE DRAWINGS

While the specification concludes with claims particularly pointing out and distinctly claiming that which are regarded as embodiments of the present disclosure, various features and advantages of this disclosure may be more readily ascertained from the following description of example embodiments of the disclosure provided with reference to the accompanying drawings, in which:

FIG. 1 is a simplified drawing illustrating an embodiment of a cushioning device of the present disclosure; and

FIGS. 2 through 4 are simplified drawings illustrating embodiments of cushioning devices of the present disclosure cushioning irregularly shaped objects.

### DETAILED DESCRIPTION

As used herein, the term “spherical objects” means and includes objects that are generally round or rounded in three-dimensional shape, although the exterior surface or surfaces of the spherical objects may be curved or planar. Thus, spherical objects may have any of the following shapes: perfect spherical, nearly perfect spherical, spherical with a flat spot, oblong, egg-shaped, multi-sided such as octagonal, or rough-sided. The spherical objects may be solid, or hollow with gaseous, liquid, or solid interiors.

As used herein, the term “microspheres” means and includes spherical objects, as defined above, having an average diameter in a range extending from about 30 microns to about 80 microns.

As used herein, the term “macrospheres” means and includes spherical objects, as defined above, having an average diameter of about 150 microns and above.

As used herein, the term “flexible container” means and includes a container capable of retaining another material, wherein the container is formed of and comprises a material or materials, such that the container may adapt under pressure to the shape of an object in contact therewith. Flexible containers may comprise sewn or woven fabrics, or films of plastic such as polyurethane, polyethylene or polyvinyl chloride, or any other flexible materials. Flexible containers may include what are often referred to in the art as “bladders,” and may define an enclosed volume therein. Flexible containers also may include a bladder having another sheet of material surrounding the bladder or attached thereto by laminating, welding, stitching, sewing, or quilting.

As used herein, the term “cushion device” means and includes any deformable device that is intended for use in cushioning one body (a person and/or object) relative to another. As a non-limiting example, cushion devices include cushions intended for use in cushioning the body of a person relative to another object that might otherwise abut against the body of the person.

As used herein, the term “substantially,” in reference to a given parameter, property or condition, means to a degree that one of ordinary skill in the art would understand that the given parameter, property, or condition is met with a small degree of variance, such as within acceptable manufacturing or measurement tolerances.

In some embodiments, the disclosure includes an ultralight flowable material comprising a plurality of macrospheres and a lubricant. The macrospheres have an average diameter of about 150 microns or above. The amount of lubricant in the ultralight flowable material is sufficient to substantially coat the exterior surface of essentially all of the macrospheres, but insufficient to cause dispersion of the macrospheres in the lubricant.

The lubricant serves to reduce the coefficient of friction between contacting macrospheres, without preventing the macrospheres from sliding and rolling with respect to each other. The lubricant does not disperse the macrospheres from one another, meaning that the spheres are not dispersed more than the distance corresponding to a film of the lubricant that is relatively thin in comparison with the average diameter of the spherical objects. If the quantity of lubricant were sufficient to cause greater dispersion, the lubricant might render the flowable material unduly heavy, and would increase its coefficient of heat transfer and thermal mass. Furthermore, such a large amount of lubricant may result in a flowable material with head pressure and, depending on the lubricant, with a greater shear force during cushioning than desired. Therefore, in accordance with the present disclosure, the amount of lubricant is a quantity at least substantially coating the exterior surfaces of substantially all of the macrospheres, but without causing dispersion of the macrospheres in the lubricant. In other words, the quantity of lubricant is insufficient to significantly physically separate the macrospheres from each other. The macrospheres would be considered significantly physically separated if the lubricant allows the macrospheres to float or move in the lubricant independent of each other rather than continually being in sliding and rolling contact with each other.

Various lubricants may be used including, but not limited to, the lubricants described in U.S. Pat. Nos. 5,592,706 and 5,829,081, which are fully incorporated herein by reference. The lubricants may be those selected from the group consisting of oils, greases, silicone-based lubricants, vegetable-based lubricants, petroleum-based lubricants, mineral-based lubricants, water-based lubricants, synthetic lubricants, or any other friction-reducing substances. Non-limiting examples of the lubricants may include white paraffinic mineral oil, propylene glycol, or glycerol.

When desired, the lubricant may further include an elastomeric polymer. The elastomeric polymer may be a random copolymer, an alternating copolymer, or a block copolymer. In certain embodiments, the elastomeric polymer may be a tri-block copolymer having a general configuration A-B-A. Non-limiting examples of suitable tri-block elastomeric copolymers may include, but not limited to, polystyrene-poly(ethylene/butylene)-polystyrene, polystyrene-hydrogenated polyisoprene-polystyrene, polystyrene-hydrogenated polybutadiene-polystyrene, or polystyrene-hydrogenated poly(isoprene-butadiene)-polystyrene.

Additionally, the putty materials described in U.S. Patent Application, Publication No. 2012/0031800, which is fully incorporated herein by reference, for the FLOWZ™ material may be used for the disclosed ultralight flowable materials.

In some embodiments, the lubricant may comprise about 99.3% by weight of white mineral oil and about 0.7% by weight of an elastomeric polymer.

The lubricant may further include a preservative to enhance stability of the lubricant. The preservative may inhibit microbial growth and/or stabilize the lubricant against oxidation or other chemical degradation. In some embodiments, the amount of preservative may be about 1% by weight or less, based on the total weight of lubricant.

The macrospheres suitable for the disclosed ultralight flowable materials may be similar in nearly all aspects to microspheres used in the FLOAM™ or FLOWZ™ materials, except that they may have substantially larger average diameters. In other embodiments, however, the macrospheres may be dissimilar to the microspheres used in the FLOAM™ or FLOWZ™ materials. As non-limiting examples, the macrospheres may be plastic-walled macrospheres such as acrylic macrospheres, or glass-walled macrospheres. Acrylic macrospheres may be preferred because they are lighter and more durable than glass-walled macrospheres.

In some embodiments, the macrospheres may have an average diameter of about 225 microns or above. In further embodiments, the macrospheres may have an average diameter of about 300 microns or above.

In some embodiments, the disclosed ultralight flowable materials comprise macrospheres that may be compressed to less than 20% of their original volume and rebound to about 100% of their original volume when the compressive force is removed. These macrospheres may also tolerate a pressure of up to about 2,000 psi without rupturing. These characteristics add to the durability and cushioning effect of the ultralight flowable materials using such macrospheres.

In some embodiments, the macrospheres may comprise acrylic macrospheres have a gaseous interior, an average diameter of about 200 microns to about 225 microns, or about 200 microns to about 300 microns or more, and a true specific gravity of 0.020 or less. Such acrylic macrospheres are commercially available from Eka Chemicals AB, of Sundsvall, Sweden, under the trade name EXPANCEL® XL101. The actual average diameter of the EXPANCEL® XL101 macrospheres depends on the processing parameters when manufacturing the macrospheres, and a particular diameter may be given a name by Eka Chemicals AB with additional designations. For example, an EXPANCEL® XL101 macrospheres with an average diameter of about 300 microns is designated EXPANCEL® XL101 DET X d25.

FLOAM™ and FLOWZ™ materials typically use microspheres having an average diameter of about 50 to about 80 microns. For example, hollow acrylic microspheres having a specific gravity of 0.015 that are commercially available from Eka Chemicals AB, of Sundsvall, Sweden, under the trade name EXPANCEL® 909 DET 80d15 microspheres may be used for the FLOAM™ or FLOWZ™ materials.

Since the EXPANCEL® 909 DET 80d15 microspheres, and the EXPANCEL® XL101 macrospheres both have the same specific gravity of 0.015, both have similar spherical shape, and both are composed of gas-filled acrylic spheres, one might expect that the flowable materials made of the EXPANCEL® XL101 macrospheres would exhibit similar properties as the flowable materials made of the EXPANCEL® 909 DET 80d15 microspheres.

Surprisingly and unexpectedly, it has been found that the specific gravity of the flowable materials may be substantially reduced (by up to 50% or more) while maintaining desirable properties of the flowable materials such as cohesiveness and non-cold-flow, when the EXPANCEL® XL101 macrospheres are used in the flowable material instead of the EXPANCEL® 909 DET 80d15 microspheres. The potential for reduction in weight while maintaining desirable properties is greater as the average diameter of the macrospheres increases. For example, at an average diameter of about 150 microns weight can be reduced; at an average diameter of about 225 microns, more weight can be reduced, and at an average diameter of about 300 microns even more weight can be reduced, all while maintaining desirable properties of the flowable materials such as cohesiveness and non-cold-flow. These remarkable and unexpected results may greatly increase the numbers of end-use applications for the ultralight flowable materials disclosed herein that have not been commercially feasible for FLOAM™ or FLOWZ™ materials.

In addition to lighter weight, the disclosed ultralight flowable materials may be lower in cost, since lower amounts (e.g., weight) of chemical components, such as lubricant, may be required for a given volume of the ultralight flowable materials compared to the FLOAM™ or FLOWZ™ materials. Furthermore, macrospheres such as those made of expanded polystyrene are much less expensive per volume than microspheres. Thus, the disclosed ultralight flowable material may offer similar flow performances, but at a lighter weight and lower cost to the FLOAM™ or FLOWZ™ materials, which are typically made of microspheres.

In additional embodiments, the present disclosure includes an ultralight flowable material comprising a plurality of spherical objects and a tacky lubricant. The spherical objects may be macrospheres, microspheres, or a combination thereof. As previously described, the amount of tacky lubricant in the ultralight flowable material is sufficient to substantially coat the exterior surface of essentially all of the spherical objects, but insufficient to cause dispersion of the spherical objects in the tacky lubricant.

The spherical objects may be solid. Alternatively, the spherical objects may be hollow with gaseous, liquid, or solid interiors. When desired, the interior of spherical objects may comprise a phase change material for temperature management capability.

In one embodiment, the spherical objects may be microencapsulated phase change materials (MPCMs), which are microspheres filled with a phase change material that when heated changes from solid to liquid (a phase change) and when cooled changes from a liquid to a solid (a phase change). The phase change temperature corresponds to the phase change material inside MPCMs, and the phase change material requires certain amounts of energy in order to go through the phase change transition. Non-limiting examples of the phase change materials inside MPCMs may include waxes, such as refined paraffin waxes. The disclosed ultralight flowable materials comprising MPCMs may be used in various applications. By way of non-limiting example, they may be used for a cushion device that is desirable to keep the cushioned object or material at a certain temperature for a period of time. For example, the disclosed ultralight flowable materials comprising MPCMs with a phase change temperature of 82° F. may be included into the mattresses or pillows or seat cushions that are conditioned at room temperature of 72° F. The user (with a skin temperature of about 98.6° F.) of such mattresses or pillows or seat cushions may feel the desirable coolness of the cushion for a longer period of time, since the phase change material inside MPCMs would require a period of time to absorb sufficient amounts of energy prior to phase change transition. Coolness is desirable to most users in most situations. Furthermore, coolness may help preventing decubitus ulcers (pressure sores), which are more likely to occur at body temperature than at the exemplary MPCM phase change temperature of 82° F. The ultralight flowable material comprising MPCMs are heavier than the ultralight flowable material without MPCMs; therefore, the cushioning device may include both the MPCMs-ultralight flowable material and the ultralight flowable material without MPCMs, with an amount of the MPCMs-ultralight flowable material sufficient to provide the temperature regulation benefit without incorporating too much weight. For example, even if the flowable material may include some percentages of MPCMs that bring a specific gravity of the disclosed flowable material back up to 0.28, such specific gravity is still ultralight when compared with any flowable materials that have a temperature regulation capability.

In one particular embodiment, the disclosed ultralight flowable materials may comprise a plurality of spherical objects and a tacky lubricant comprising a mineral oil having a Saybolt viscosity of more than about 70 SUS at 100° F. according to the ASTM D-2161 standard method (e.g., such as a mineral oil of viscosity grade 500 SUS).

In some embodiments, the disclosed ultralight flowable materials may comprise a plurality of spherical objects and a tacky lubricant comprising a mineral oil having a Saybolt viscosity of about 500 SUS or more at 100° F. according to the ASTM D-2161 standard method.

The ultralight flowable materials may comprise the same microspheres as those used in the FLOAM™ or FLOWZ™ materials, and a tacky lubricant instead of the typical lubricant used in the FLOAM™ or FLOWZ™ materials. These ultralight flowable materials may show a significant reduction in specific gravity, compared to the FLOAM™ or FLOWZ™ materials. For example, when a tacky lubricant (e.g., mineral oil of viscosity grade 500 SUS) is used as the lubricant for the FLOAM™ material instead of the mineral oil of viscosity grade 70 SUS, the resulting flowable material shows a substantially lower specific gravity and yet similar desirable performances to the FLOAM™ material using mineral oil of viscosity grade 70 SUS.

In other particular embodiment, the disclosed ultralight flowable materials may comprise a plurality of spherical objects and a tacky lubricant comprising polybutene. Polybutene is inherently tacky and lubricious.

The tacky lubricant may have a relatively low specific gravity and may not degrade or break down over time, so that the resulting ultralight flowable materials may be lightweight, durable, and may not vary significantly in performance with variations in temperature. In some embodiments, the lubriciousness of the tacky lubricants may not substantially change through the temperature range of ordinary outdoor temperatures (i.e., 0° F. to 120° F.). It is desirable that the tacky lubricants exhibit resistance to a change in lubriciousness in order to avoid substantial variance in essential performance characteristics of the ultralight flowable materials with changes in temperature. Additionally, an antifreeze material may be added to the lubricant to expand the operable temperature range of the lubricant. Suitable antifreezes may include, but are not limited to, propylene glycol and ethylene glycol.

When desired, the tacky lubricant may include a tackifying agent to further increase the tackiness of the lubricant. Non-limiting examples of suitable tackifying agents may include, but are not limited to, an A-B-A triblock copolymer, an elastomeric copolymer, a tackifying resin or a combination thereof. By way of non-limiting example, the A-B-A triblock copolymers may be KRATON® G1651 copolymer, which is a linear copolymer based on styrene and ethylene/butylene with a polystyrene content of 33%, available from Kraton Performance Polymers, Inc. Non-limiting examples of suitable elastomeric copolymers may be any elastomeric copolymers described in the aforementioned FLOWZ™ patent applications, such as KRATON® 2002 copolymer.

The disclosed ultralight flowable materials composed of tacky lubricant show desirably increased cohesiveness and lower specific gravity compared to the flowable materials composed of non-tacky lubricant and similar spherical objects, regardless of whether the spherical objects are macrospheres or microspheres. When tacky lubricant is used in combination with macrospheres, however, the resulting ultralight flowable materials may exhibit even further enhanced cohesiveness and reduced specific gravity.

Accordingly, in some embodiments of present disclosure, the ultralight flowable materials may comprise a plurality of macrospheres and a tacky lubricant. Such ultralight flowable materials may exhibit up to 90% weight reduction compared to the FLOAM™ or FLOWZ™ materials. In some embodiments, such ultralight flowable materials may have about 40% to 70% weight reduction compared to the FLOAM™ or FLOWZ™ materials.

Non-limiting examples of macrospheres suitable for present disclosure may include, but not limited to, expanded polystyrene macrospheres, oblong macrospheres of expanded polyethylene, or oblong macrospheres of polypropylene.

When expanded polystyrene macrospheres are used in combination with tacky lubricant, the disclosed ultralight flowable materials have substantially lower specific gravity than any known flowable materials that use expanded polystyrene macrospheres in combination with water-based lubricant or non-tacky lubricant.

When a tacky lubricant is used in combination with macrospheres having an average diameter larger than 200 microns, the tacky lubricant may improve the cohesiveness between of the macrospheres. Thus, the ultralight flowable material may be suitable for cushioning or padding applications, especially in applications like pillows and mattresses where the graininess of the macrospheres is small compared to the size of the pillows and mattresses.

The disclosed ultralight flowable materials are not simple fluids, such as liquids or gases, but they are composite materials composed of spherical objects (either macrospheres or microspheres) mixed with at least one non-gas fluid material.

The ultralight flowable materials of present disclosure may have a specific gravity of about 0.02 to about 0.17. In certain embodiments, the ultralight flowable materials may have a specific gravity of about 0.02 to about 0.10. In further embodiments, the ultralight flowable materials may have a specific gravity of about 0.03 to about 0.10.

The disclosed ultralight flowable materials may have a comparable specific gravity to the conventional cushion foams, which are from about 0.03 to about 0.10.

As discussed previously, the FLOAM™ materials comprise a plurality of microspheres mixed with a quantity of a lubricant sufficiently to substantially coat the exterior surface of essentially all of the microspheres, but insufficient to cause dispersion of the microspheres in the lubricant. The FLOAM™ materials typically use microspheres having an average diameter of about 30 microns to about 80 microns. The microspheres most often employed in the FLOAM™ material are acrylic microspheres having a specific gravity of about 0.015 to about 0.020. The lubricants used in the FLOAM™ material generally have a specific gravity of about 0.8 to about 1.2, more typically about 0.85 to about 0.90. Therefore, the overall weight of the FLOAM™ material comes mostly from the weight of the lubricant and not from the microspheres. In order to maintain cohesiveness and adequate ease of flow for most cushioning applications, a sufficient weight of the lubricant is used in the FLOAM™ material. As such, the FLOAM™ materials suitable for most cushioning applications generally have a specific gravity of about 0.20 to about 0.32 when the 0.015-specific-gravity microspheres are used. The FLOAM™ material having a specific gravity of 0.20 tends to lose cohesiveness and requires a higher than desirable pressure level to flow. The FLOAM™ materials having a specific gravity lower than 0.02 may have insufficient cohesiveness, causing such FLOAM™ materials to break apart randomly. Furthermore, the FLOAM™ materials having a specific gravity lower than 0.02 may require so much pressure to flow that the cushioning performance of such FLOAM™ materials may not be achievable. The FLOAM™ materials having a specific gravity greater than 0.32 (using the 0.015-specific-gravity microspheres) may be highly flowable, but may begin to tend toward cold flow or float-out of the microspheres from the lubricant. For most applications, the FLOAM™ materials having a specific gravity of 0.28 sccm to be optimum.

The FLOWZ™ materials generally have much higher specific gravity than the FLOAM™ materials. However, when sufficient quantity of the 0.015-specific-gravity microspheres are added to the FLOWZ™ materials, the FLOWZ™ materials may achieve the same levels of cohesiveness and flowability as the FLOAM™ materials, but at somewhat lower density. For example, the cohesiveness and flow properties of the 0.28-specific-gravity FLOAM™ materials may be matched by the FLOWZ™ materials having a specific gravity from about 0.22 to about 0.25.

The ultralight flowable materials of the present disclosure having a specific gravity from about 0.08 to about 0.12 may provide the same levels of cohesiveness and flow properties as the 0.28-specific-gravity FLOAM™ material and the 0.22-specific-gravity FLOWZ™ material. It has been found that even at such ultralight specific gravity (i.e., density), the disclosed ultralight flowable materials may still exhibit desirable cohesiveness, flow under light pressure to a new shape, and exhibit little or no rebound force on the object causing reshaping after being deformed. Furthermore, even at such ultralight specific gravity, the disclosed ultralight flowable materials may not exhibit liquid-like cold flow (i.e., not form an ever spreading puddle but, to at least a partial extent, stay in the shape to which it was formed).

Thus, the disclosed ultralight flowable materials have a substantially lower specific gravity than FLOAM™ and FLOWZ™ materials for a given set of material properties (in particular ease of flow and degree of cohesiveness), while maintaining, if not enhancing, the desirable properties of the FLOAM™ and FLOWZ™ materials. Non-limiting examples of the desirable properties may include, but are not limited to, (i) low thermal mass, (ii) low coefficient of heat transfer, (iii) good flowability and cohesiveness, (iv) low shearing force threshold, (v) minimal or no memory, (vi) equalization of pressure across the area of skin contacted to prevent skin damage, (vii) minimal or no substantial change in performance with change in temperature throughout the anticipated range of temperatures to be encountered during use, and (viii) minimal or no separation into their constituent components over time.

The disclosed ultralight flowable materials may deform, flow or shear under light pressure, but cease to flow, shear or deform when the pressure is terminated. The flow and shear of the ultralight flowable material are accomplished by moving the spherical objects in rolling and sliding contact with each other.

The disclosed ultralight flowable materials may have a thermal mass less than about 0.7 calories per cubic centimeter per degree Celsius. Furthermore, the ultralight flowable materials may have a coefficient of heat transfer less than about 0.25 btu per hour per foot per degree Fahrenheit.

The lighter weight of the disclosed ultralight flowable materials allows their commercial uses to be feasible in various applications that have not been achieved by the FLOAM™ and FLOWZ™ materials due to weight limitations. As a non-limiting example to illustrate the effect of weight limitation, if a king size mattress is to be filled with about 15 cubic feet of the flowable materials for a given set of material properties, such mattress will need about 262 pounds of the FLOAM™ material (specific gravity of 0.28), or about 206 pounds of the FLOWZ™ material (specific gravity of 0.22). However, such a mattress will need only about 75 pounds of the disclosed ultralight flowable material (specific gravity of 0.08). Of these three weights, only a 75-pound king size mattress is likely to be commercially feasible because most consumers and retailers would object to the mattresses that weigh more than 150 pounds. As another non-limiting example to illustrate the effect of weight limitation, if a 16-inch×18-inch×3.5-inch wheelchair cushion (0.58 cubic feet) is to be filled with flowable material, such a wheelchair cushion would need about 10 pounds of the FLOAM™ material, or about 8 pounds of the FLOWZ™ material. However, such a wheelchair cushion will need only about 3 pounds of the disclosed ultralight flowable materials having a specific gravity of 0.08. The 8-pound and 10-pound wheelchair cushions would be objectionable to many users, sellers and prescribers of the cushions, but 3-pound cushions would be acceptable to all three.

In some embodiments, the disclosure includes an article of manufacture that comprises a flexible container and an ultralight flowable material contained inside the flexible container.

Non-limiting examples of flexible containers may include, but are not limited to, a sealed bladder made of thin plastic film, a sealed bladder made of a fabric laminated to thin plastic film, and sealed bladder made of a tight-weave fabric.

Any flexible or pliable materials may be used for the flexible container. Non-limiting examples may include, but are not limited to, polyurethane, polyolefin, latex, rubber, synthetic rubbers, thermoplastic elastomers, EVA polymer, or any other thin, flexible, fluid impermeable or low-permeability film. The flexible container may have one or more layers of such flexible or pliable materials disposed on either side of the disclosed ultralight flowable materials. The flexible container may be fluid-tight with respect to a selected lubricant, and thereby resists bleeding or evaporation of the lubricant through the walls of the container. The flexible container may include a laminated fabric formed by various known methods of manufacturing or by attaching layers of fabric. Such methods may include, but are not limited to, laminating the fabric and film together using heat welding, radio frequency welding or ultrasonic welding.

The flexible or pliable materials used for the flexible container may be any desired thickness. In some embodiments, the thickness of flexible or pliable materials may be from about 0.001 inches to about 0.300 inches. In some embodiments, the thickness of flexible or pliable materials may be less than about 0.020 inches. In certain embodiments, the thickness of flexible or pliable materials may be from about 0.001 inches to about 0.006 inches to provide sufficient flexibility while remaining fluid-tight.

In some embodiments, the flexible container may comprise thermoplastic polyurethane film having a thickness of about 0.002 inches to about 0.012 inches thick. The thicker the thermoplastic polyurethane film, the stronger the article of manufacture is, but the lower ability of the article of manufacture to deform around the irregularities of a cushioned object or body part.

The flexible containers may be filled with the disclosed ultralight flowable materials by removing air from the flexible containers and then injecting the disclosed ultralight flowable materials, thereby preventing any relatively large volumes of air from being present in the containers. The flexible containers may only be partially filled with the disclosed ultralight flowable materials in some embodiments. The container and the ultralight flowable material therein may be configured to permit movement of the disclosed ultralight flowable material inside the container and to achieve the desired cushioning properties. The volume of the disclosed ultralight flowable materials in the container may be increased to provide a stiffer cushion or decreased to provide a more flowable cushion as desirable.

It is desirable to neither underfill nor overfill the flexible container with the disclosed ultralight flowable materials, although the extent of fill may vary with the intended application. Overfilling may interfere with an ability of the ultralight flowable material to conform its shape to the cushioned object or body part. Underfilling may result in bottoming out of the cushioned object or body part onto the underlying material beneath the article of manufacture. A properly filled container is loose enough that it may deform to the shape of the cushioned object, and then hammock (tensioning the container) after conforming but before the cushioned object or body part bottoms out.

In most embodiments of present disclosure, the flexible container may be less than 80% full with ultralight flowable materials, although completely full or nearly empty flexible containers may be employed. In some embodiments, the flexible container may be about 30% to 50% filled by volume with the ultralight flowable materials.

The disclosed articles of manufacture may be used for various applications. Non-limiting examples of the articles of manufacture may include, but are not limited to, cushions (either medical or non-medical types), toys, life jackets, clothing and outerwear, positioners (e.g., surgical positioners, neonatal positioners, MRI hold-still positioners, and other medical positioners), surgical table pads, product packaging, modeling compounds for children at play or for artists or others, products designed for shock absorption, products designed for vibration attenuation, immobilization devices (e.g., casts, splints, and wraps for sprains and broken bones, post-surgery immobilization products), and tire fill. When the ultralight flowable materials include compressible spherical objects, the ultralight flowable material may be used in the articles of manufacture that allow energy return following compression, such as during walking or running.

In one embodiment of present disclosure, a cushion device comprises a flexible container and an ultralight flowable material contained inside the flexible container.

When desired, the cushion device may include multiple compartment bladders or a plurality of individual bladders. For example, a mattress pad would typically include numerous small individual bladders, while an automobile seat could be constructed either with numerous small individual bladders, from one large bladder or from one compartmentalized bladder having multiple compartments.

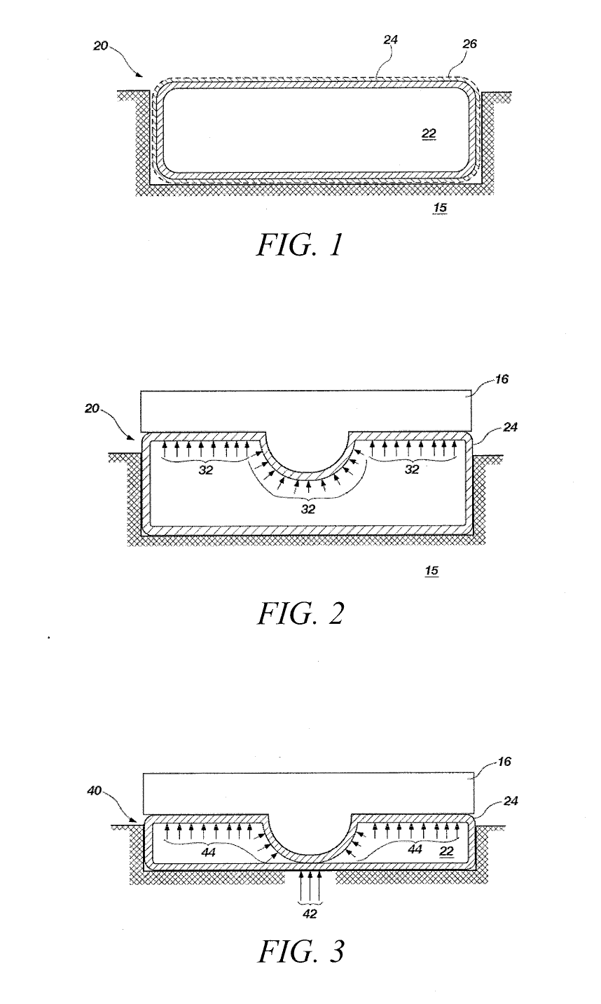

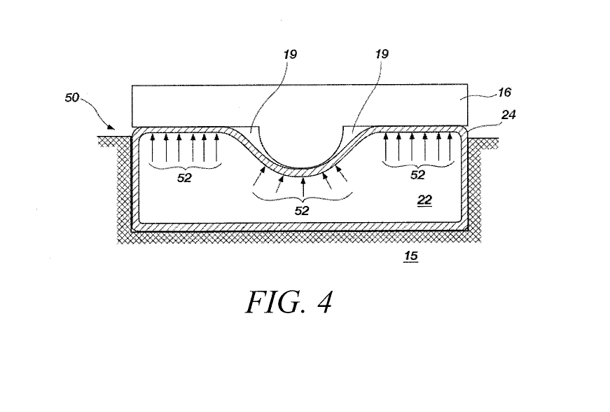

As shown in FIG. 1, a cushion 20 may comprise an ultralight flowable material 22 disposed in a flexible container 24. The cushion 20 may have an optional cover 26 and may be disposed within an optional base 15. As shown in FIG. 2, when an object or body part 16 is placed upon or against the cushion 20, the ultralight flowable material 22, flexible container 24 (i.e., a bladder), and optional cover 26 (not shown in FIG. 2) may deform to correspond to the contours of the object or body part 16. The ultralight flowable material 22 may exert low spring-back pressure (i.e., the ultralight flowable material 22 may have a lower force opposite the direction of its deformation than does a conventional cushioning material). Therefore, a pressure 32 of the cushion 20 on the object or body part 16 may be approximately constant across the surface of the object or body part 16 in contact with the cushion 20. Furthermore, because the pressure 32 acts over a relatively larger area compared to conventional foam cushions, the magnitude of the pressure 32 supporting the object or body part 16 with cushion 20 is less than the magnitude of the peak pressure supporting the same object or body part 16 with a conventional foam cushion.

The flexible container 24 may comprise any flexible material, such as fabric or plastic or gelatinous elastomer. The flexible container 24 may comprise a porous or nonporous material. Flexible containers 24 comprising fabric may be less expensive than flexible containers 24 comprising plastic, and may have a more natural or comfortable feel for human and animal users than plastic. The flexible container 24 may confine the ultralight flowable material 22 (i.e., may tend to conform the ultralight flowable material 22 to the shape of the flexible container 24 as the flexible container 24 changes its shape).

In some embodiments, cushioning materials 22 may be confined within or along a nonporous material, for example in a flexible container 24 made from a polymer film, such as thermoplastic polyurethane, a gelatinous elastomer, or other elastomeric or pliable material. Flexible containers 24 may be of any selected thickness, for example from 0.051 mm (0.002 in) thick to 7.62 mm (0.300 in) thick. Thicker films of a given material may be stronger than thinner films of that material, but may have lower “hand” (i.e., ability to deform around irregularities of a cushioned object or body part 16). For example, if the flexible container 24 comprises a polyurethane film, the average thickness of the polyurethane film may be between about 0.051 mm (0.002 in) and about 0.305 mm (0.012 in). If the flexible container 24 comprises a gelatinous elastomer, the average thickness of the gelatinous elastomer film may be between about 0.51 mm (0.020 in) and about 7.62 mm (0.300 in). Non-limiting general examples describing the use of fluid containers for cushioning are described in U.S. Pat. No. 5,592,706, issued Jan. 14, 1997 to Pearce, which is incorporated herein in its entirety by reference.

An optional cover 26 may be disposed over or around the container 24, as shown in FIG. 1. For example, a fabric cover 26 may cover a nonporous container 24 (e.g., a thermoplastic polyurethane film flexible container 24 having a ultralight flowable material 22 sealed inside it). The optional cover 26 may be permanently affixed to the container 24, or may be removable. Though not shown in FIGS. 2 through 4, any of the cushions 20 described herein may comprise optional covers 26.

The cushion 20 shown in FIG.1 may be disposed on or within a base 15. For example, the base 15 may comprise a seat support, such as wheelchair or office chair. The base 15 may define an open cavity in which the cushion 20 may fit. In embodiments in which a cushion 20 is placed within an open cavity, a wall of the cavity may support at least a portion of the cushion disposed therein. The base 15 may comprise a material that is more rigid than the cushion 20, such as a firm polyethylene foam.

The amount of ultralight flowable material 22 placed within a flexible container 24 may be selected such that an object or body part 16 may deform the flexible container 24 to conform with the shape of the cushioned object or body part 16. The flexible container 24 may tension (or “hammock”) after conforming to the shape of the object or body part 16 before the cushioned object or body part 16 “bottoms out,” as shown in FIG. 3. As shown in FIG. 3, a cushion 40 with an underfilled flexible container 24 deforms to correspond with the contours of the object or body part 16, but the object or body part 16 bottoms out by pushing at least a portion of opposing sides of the flexible container 24 together. If the object or body part 16 bottoms out, it may not be supported entirely by the cushion 40, but may be at least partially supported by a surface of the base 15 against which the cushion 40 rests. An underfilled cushion 40 may not provide adequate support for the object or body part 16 because the object or body part 16 may be resting against the base 15. Thus, there may be areas of higher pressure 42 corresponding with areas of the object or body part 16 unsupported by the cushion 40. Furthermore, since the ultralight flowable material 22 exerts little to no spring-back pressure, and because the ultralight flowable material 22 has additional space in which it may deform, the pressure 44 of the ultralight flowable material 22 on a bottomed-out object or body part 16 may be minimal.

As shown in FIG. 4, an overfilled cushion 50 may hammock before conforming to the shape of the cushioned object or body part 16. As a result, there may be spaces or gaps 19 between the overfilled cushion 50 and areas of the object or body part 16 that are unsupported by the overfilled cushion 50. Because the overfilled cushion 50 provides support over a smaller contact area, the pressure 52 on the supported object or body part 16 may be higher than in a properly filled cushion (i.e., a cushion 20 that hammocks after conforming to the shape of the object or body part 16, as shown in FIG. 2).

A person having ordinary skill in the art will recognize that a proper amount of ultralight flowable material 22 needed to form a cushion 20 may depend on the shape, size, and weight of the object or body part 16 to be cushioned. The proper amount of ultralight flowable material 22 may also depend on the size, shape, and properties (e.g., thickness, stiffness, etc.) of the flexible container 24. Furthermore, an appropriate amount of ultralight flowable material 22 may vary based on the properties of the ultralight flowable material 22 itself. A cushion 20 that is properly filled for one application may be underfilled for another application and overfilled for yet another application.

The disclosed cushion devices may be suitable for a variety of applications including, but are not limited to, those applications described in U.S. Pat. Nos. 5,592,706 and 5,829,081, which are fully incorporated herein by reference. Further non-limiting examples of such cushion devices may include wheelchair cushions, medical mattresses or mattress overlays for healing or preventing tissue damage (e.g., decubitus ulcers), medical heel cushions (within a mattress or independently), orthopedic products (e.g., padding for ankle braces, knee braces, and elbow braces), knee pads, medical elbow pads, protective padding for sports (e.g., cushioning in shin guards, elbow guards, wrist guards, boxing gloves, and helmets), medical pillows, consumer pillows, consumer mattresses or mattress overlays, shoes (e.g., cushioning in the tongue of a shoe, or in the upper of a shoe for example over the ankle bones, or in the sock insert of a shoe, or in the bed of a shoe), foot care products (e.g., partial or full insoles, heel cups, toe spacers, or ball of foot cushions), pads for preventing falling out of bed or softening the landing in the event of falling out of bed, stretchers and gurneys (in some cases including those through which X-rays may be taken without undue interference by the cushioning medium), consumer seat cushions, hunting seat cushions, back support cushions, lumbar support cushions, furniture cushions, foot mats (e.g., for near front doors of homes, or for surgeons or nurses or dentists to stand on, or for cashiers or machinists to stand on), bath mats (in or out of the shower/tub), recliner foot support cushions, outdoor furniture cushions, boat seat cushions, automotive and semi-truck and heavy equipment seating (original equipment and aftermarket), animal transport cushioning, kayak seat cushions, office chair cushions, stadium seating, gardening pads, between-knee cushions, neck support cushions, after-market cushions for use on furniture or beds or the like, carpet or rug cushioning, travel cushions, comforters or quilts or blankets, surgical and other tourniquets, ballet slippers and inserts over foot parts of a ballerina or within a ballet slipper, baseball mitts, coats and jackets, cold weather gloves, work gloves (e.g., general work gloves, gloves for jack hammers, padded work gloves, insulated work gloves), protective gloves, landing pads and protective pads for sports in which the participant impacts a cushion (e.g., jumpers, gymnasts, marshal artists, wrestlers, and climbers), wrist and mouse pads for use with keyboards or computers or the like, punching bags, punchable manikins and other punchable or kickable or graspable items, straps (e.g., for backpacks, golf bags, luggage, briefcases, purses, brassieres, duffle bags, binoculars, safety gear, parachutes, seat belts, shoulder belts (as part of the belt or as an after-market add-on, and medical slings. Additionally, the disclosed cushion devices may be useful as impact bumpers for vehicles and occupants thereof, and they may be placed either internal and/or external to the vehicles.

### EXAMPLES

### Example 1

### Ultralight Flowable Material Having a Specific Gravity of About 0.14

A tacky lubricant was prepared by heat blending about 100 parts by weight of CARNATION® 70 mineral oil (available from Sonneborn, LLC of Parsippany, N.J.) with 1 part by weight of KRATON® G1651 styrene and ethylene/butylene copolymer (available from Kraton Performance Polymers, Inc.) and 15 parts by weight of LUHOREZ hydrocarbon tackifying resin, and then allowing the resulting blend to cool down. Sufficient amounts of the tacky lubricant were thoroughly mixed with the EXPANCEL® XL101 DET X d25 macrospheres (available from Eka Chemicals) to provide an ultralight flowable material having a specific gravity of about 0.14.

A comparative FLOAM™ material was prepared by heat blending 100 parts by weight of CARNATION® 70 mineral oil with 1 part by weight of KRATON® G1651 styrene and ethylene/butylene copolymer, and then allowing the resulting blend to cool down. The resulting lubricant was then thoroughly mixed with the EXPANCEL® 909 DET 80d15 microspheres (available from Eka Chemicals) to provide a FLOAM™ material having a specific gravity of about 0.28.

The ultralight flowable material having a specific gravity of about 0.14 was tested for ease of flow and cohesiveness in comparison to the comparative FLOAM™ material having a specific gravity of about 0.28. The ultralight flowable material showed similar desirable properties as the comparative FLOAM™ material, but at about 50% weight reduction compared to the comparative FLOAM™ material.

### Example 2

### Ultralight Flowable Material Having a Specific Gravity of About 0.10

A tacky lubricant was prepared by heat blending about 100 parts by weight of CARNATION® 70 mineral oil with 12 parts by weight of KRATON® 2002 elastomeric copolymer to form a flowable putty material, which was then modified with 15 parts by weight of LUHOREZ tackifying resin, and cooled down. Sufficient amounts of the tacky putty lubricant were thoroughly mixed with the EXPANCEL® XL101 DET X D25 macrospheres to provide an ultralight flowable material having a specific gravity of about 0.10.

A comparative FLOAM™ material having a specific gravity of about 0.28 was prepared as shown in EXAMPLE 1, and tested for ease of flow and cohesiveness in comparison to the ultralight flowable material having a specific gravity of about 0.10. The ultralight flowable material having a specific gravity of about 0.10 showed similar desirable properties as the comparative FLOAM™ material, but at about 64% weight reduction compared to the comparative FLOAM™ material.

A comparative FLOWZ™ material was prepared by heat blending about 100 parts by weight of CARNATION® 70 mineral oil with 12 parts of KRATON® 2002 elastomeric copolymer, and then allowing to cool down to provide a tacky putty lubricant. Sufficient amounts of the tacky putty lubricant were then thoroughly mixed with the EXPANCEL® 909 DET 80d15 microspheres to provide a FLOWZ™ material having a specific gravity of about 0.22.

The ultralight flowable material having a specific gravity of about 0.10 was tested for ease of flow and cohesiveness in comparison to the comparative FLOWZ™ material having a specific gravity of about 0.22. The ultralight flowable material showed similar desirable properties as the comparative FLOWZ™ material, but at about 55% weight reduction compared to the comparative FLOWZ™ material.

Additional non-limiting example embodiments are set forth below.

Embodiment 1: An ultralight flowable material, comprising: a plurality of macrospheres having an average diameter of about 150 microns or above; and a lubricant in an amount substantially coating the exterior surfaces of essentially all macrospheres of the plurality and without causing dispersion of the macrospheres of the plurality in the lubricant; wherein the ultralight flowable material has a specific gravity of 0.17 or less.

Embodiment 2: The ultralight flowable material of Embodiment 1, wherein the macrospheres have an average diameter of about 225 microns or above.

Embodiment 3: The ultralight flowable material of Embodiment 1, wherein the macrospheres have an average diameter of about 300 microns or above.

Embodiment 4: The ultralight flowable material of any one of Embodiments 1 through 3, wherein the lubricant comprises a member selected from the group consisting of oils, greases, silicone-based lubricants, vegetable-based lubricants, petroleum-based lubricants, mineral-based lubricants, water-based lubricants, and synthetic lubricants.

Embodiment 5: The ultralight flowable material of any one of Embodiments 1 through 4, wherein the lubricant further comprises an elastomeric polymer.

Embodiment 6: The ultralight flowable material of Embodiment 5, wherein the elastomeric polymer comprises a polymer selected from the group consisting of polystyrene-poly(ethylene/butylene)-polystyrene, polystyrene-hydrogenated polyisoprene-polystyrene, polystyrene-hydrogenated polybutadiene-polystyrene, and polystyrene-hydrogenated poly(isoprene-butadiene)-polystyrene.

Embodiment 7: The ultralight flowable material of any one of Embodiments 1 through 6, wherein the macrospheres of the plurality comprise a member selected from the group consisting of acrylic macrospheres, expanded polystyrene macrospheres, oblong macrospheres of expanded polyethylene, and oblong macrospheres of polypropylene.

Embodiment 8: The ultralight flowable material of any one of Embodiments 1 through 7, wherein the macrospheres of the plurality are hollow and comprise an inert gaseous interior.

Embodiment 9: The ultralight flowable material of any one of Embodiments 1 through 8, wherein the macrospheres of the plurality are hollow and comprise an outer shell selected from the group consisting of plastic, glass, metal, carbon, mineral, and quartz.

Embodiment 10: The ultralight flowable material of any one of Embodiments 1 through 9, wherein the macrospheres of the plurality comprise an acrylic outer shell and a gaseous interior, an average diameter of about 200 microns or more, and a true specific gravity of 0.020 or less.

Embodiment 11: The ultralight flowable material of any one of Embodiments 1 through 10, wherein the ultralight flowable material has a specific gravity in a range extending from about 0.03 to about 0.10.

Embodiment 12: An ultralight flowable material, comprising: a plurality of spherical objects comprising microspheres, macrospheres, or a combination thereof; and a tacky lubricant in an amount substantially coating the exterior surfaces of essentially all spherical objects of the plurality and without causing dispersion of the spherical objects of the plurality in the tacky lubricant.

Embodiment 13: The ultralight flowable material of Embodiment 12, wherein the tacky lubricant comprises a mineral oil having a Saybolt viscosity of about 70 SUS or more at 100° F., and wherein the mineral oil is blended with at least one of an elastomeric polymer and a tackifying agent.

Embodiment 14: The ultralight flowable material of Embodiment 12 or Embodiment 13, wherein the tacky lubricant comprises a mineral oil having a Saybolt viscosity of about 500 SUS or more at 100° F.

Embodiment 15: The ultralight flowable material of any one of Embodiments 12 through 14, wherein the tacky lubricant comprises polybutene.

Embodiment 16: The ultralight flowable material of any one of Embodiments 12 through 15, wherein the tacky lubricant further comprises a tackifying agent.

Embodiment 17: The ultralight flowable material of Embodiment 16, wherein the tackifying agent comprises a material selected from the group consisting of A-B-A triblock copolymers, elastomeric copolymers, and tackifying resins.

Embodiment 18: The ultralight flowable material of any one of Embodiments 12 through 17, wherein the spherical objects of the plurality are microspheres having an average diameter in a range extending from about 30 microns to about 80 microns.

Embodiment 19: The ultralight flowable material of any one of Embodiments 12 through 18, wherein the spherical objects of the plurality comprise microencapsulated phase change materials.

Embodiment 20: The ultralight flowable material of any one of Embodiments 12 through 17 and 19, wherein the spherical objects of the plurality are macrospheres having an average diameter of about 150 microns or above.

Embodiment 21: The ultralight flowable material of any one of Embodiments 12 through 17 and 19, wherein the spherical objects of the plurality are macrospheres having an average diameter of about 225 microns or above.

Embodiment 22: The ultralight flowable material of any one of Embodiments 12 through 17 and 19, wherein the spherical objects of the plurality are macrospheres having an average diameter of about 300 microns or above.

Embodiment 23: The ultralight flowable material of any one of Embodiments 12 through 22, wherein the ultralight flowable material has a specific gravity in a range extending from about 0.02 to about 0.17.

Embodiment 24: An article of manufacture, comprising: a flexible container; and an ultralight flowable material contained within the flexible container, wherein the ultralight flowable material comprises: a plurality of spherical objects comprising microspheres, macrospheres, or a combination thereof; and a tacky lubricant in an amount to substantially coat the exterior surfaces of essentially all spherical objects but less than an amount to cause dispersion of the spherical objects in the tacky lubricant.

Embodiment 25: The article of manufacture of Embodiment 24, wherein the flexible container is a sealed bladder at least one of a thin plastic film, a fabric laminated to a thin plastic film, and a tight-weave fabric.

Embodiment 26: The article of manufacture of Embodiment 24 or Embodiment 25, wherein the plurality of spherical objects comprises microencapsulated phase change materials; and wherein the tacky lubricant comprises at least one of a mineral oil having a Saybolt viscosity of at least about 70 SUS at 100° F. blended with at least one of an elastomeric polymer and a tackifying agent, a mineral oil having a Saybolt viscosity of about 500 SUS or more at 100° F., and polybutene

Embodiment 27: The article of manufacture of Embodiment 24 or Embodiment 25, wherein the plurality of spherical objects comprises a plurality of macrospheres, the plurality of macrospheres having an average diameter of at least about 150 microns or above; and wherein the tacky lubricant comprises at least one of a mineral oil having a Saybolt viscosity of at least about 70 SUS at 100° F. blended with at least one of an elastomeric polymer and a tackifying agent, a mineral oil having a Saybolt viscosity of about 500 SUS or more at 100° F., and polybutene.

Embodiment 28: The article of manufacture of Embodiment 24 or Embodiment 25, wherein the plurality of spherical objects comprises a plurality of macrospheres, the plurality of macrospheres having an average diameter of at least about 225 microns or above; and wherein the tacky lubricant comprises at least one of a mineral oil having a Saybolt viscosity of at least about 70 SUS at 100° F. blended with at least one of an elastomeric polymer and a tackifying agent, a mineral oil having a Saybolt viscosity of about 500 SUS or more at 100° F., and polybutene.

Embodiment 29: The article of manufacture of Embodiment 24 or Embodiment 25, wherein the plurality of spherical objects comprises a plurality of macrospheres, the plurality of macrospheres having an average diameter of at least about 300 micron or above; and wherein the tacky lubricant comprises at least one of a mineral oil having a Saybolt viscosity of at least about 70 SUS at 100° F. blended with at least one of an elastomeric polymer and a tackifying agent, a mineral oil having a Saybolt viscosity of about 500 SUS or more at 100° F., and polybutene

Although the foregoing description contains many specifics, these are not to be construed as limiting the scope of the present compositions and devices, but merely as providing certain embodiments. Similarly, other embodiments of the compositions and devices may be devised that do not depart from the scope of the present disclosure. For example, features described herein with reference to one embodiment also may be provided in others of the embodiments described herein. The scope of the invention is, therefore, indicated and limited only by the appended claims and their legal equivalents, rather than by the foregoing description. All additions, deletions, and modifications to the compositions and devices, as disclosed herein, which fall within the meaning and scope of the claims, are encompassed by the present invention.

What is claimed is:

1. An ultralight flowable material, comprising:
a plurality of macrospheres having an average diameter of about 150 microns or above; and
a lubricant in an amount substantially coating the exterior surfaces of essentially all macrospheres of the plurality and without causing dispersion of the plurality of macrospheres in the lubricant; wherein the ultralight flowable material has a specific gravity of 0.17 or less.

2. The ultralight flowable material of claim 1, wherein the macrospheres have an average diameter of about 225 microns or above.

3. The ultralight flowable material of claim 1, wherein the macrospheres have an average diameter of about 300 microns or above.

4. The ultralight flowable material of claim 1, wherein the lubricant comprises a member selected from the group consisting of oils, greases, silicone-based lubricants, vegetable-based lubricants, petroleum-based lubricants, mineral-based lubricants, water-based lubricants, and synthetic lubricants.

5. The ultralight flowable material of claim 1, wherein the lubricant further comprises an elastomeric polymer.

6. The ultralight flowable material of claim 5, wherein the elastomeric polymer comprises a polymer selected from the group consisting of polystyrene-poly(ethylene/butylene)-polystyrene, polystyrene-hydrogenated polyisoprene-polystyrene, polystyrene-hydrogenated polybutadiene-polystyrene, and polystyrene-hydrogenated poly(isoprene-butadiene)-polystyrene.

7. The ultralight flowable material of claim 1, wherein the macrospheres of the plurality comprise a member selected from the group consisting of acrylic macrospheres, expanded polystyrene macrospheres, oblong macrospheres of expanded polyethylene, and oblong macrospheres of polypropylene.

8. The ultralight flowable material of claim 1, wherein the macrospheres of the plurality are hollow and comprise an inert gaseous interior.

9. The ultralight flowable material of claim 1, wherein the macrospheres of the plurality are hollow and comprise an outer shell selected from the group consisting of plastic, glass, metal, carbon, mineral, and quartz.

10. The ultralight flowable material of claim 1, wherein the macrospheres of the plurality comprise an acrylic outer shell and a gaseous interior, an average diameter of about 200 microns or more, and a true specific gravity of 0.020 or less.

11. The ultralight flowable material of claim 1, wherein the ultralight flowable material has a specific gravity in a range extending from about 0.03 to about 0.10.

12. An ultralight flowable material, comprising:
a plurality of spherical objects comprising microspheres, macrospheres, or a combination thereof; and
a tacky lubricant in an amount substantially coating the exterior surfaces of essentially all spherical objects of the plurality and without causing dispersion of the spherical objects of the plurality in the tacky lubricant.

13. The ultralight flowable material of claim 12, wherein the tacky lubricant comprises a mineral oil having a Saybolt viscosity of about 70 SUS or more at 100° F., and wherein the mineral oil is blended with at least one of an elastomeric polymer and a tackifying agent.

14. The ultralight flowable material of claim 12, wherein the tacky lubricant comprises a mineral oil having a Saybolt viscosity of about 500 SUS or more at 100° F.

15. The ultralight flowable material of claim 12, wherein the tacky lubricant comprises polybutene.

16. The ultralight flowable material of claim 12, wherein the tacky lubricant further comprises a tackifying agent.

17. The ultralight flowable material of claim 16, wherein the tackifying agent comprises a material selected from the group consisting of A-B-A triblock copolymers, elastomeric copolymers, and tackifying resins.

18. The ultralight flowable material of claim 12, wherein the spherical objects of the plurality are microspheres having an average diameter in a range extending from about 30 microns to about 80 microns.

19. The ultralight flowable material of claim 12, wherein the spherical objects of the plurality comprise microencapsulated phase change materials.

20. The ultralight flowable material of claim 12, wherein the spherical objects of the plurality are macrospheres having an average diameter of about 150 microns or above.

21. The ultralight flowable material of claim 12, wherein the spherical objects of the plurality are macrospheres having an average diameter of about 225 microns or above.

22. The ultralight flowable material of claim 12, wherein the spherical objects of the plurality are macrospheres having an average diameter of about 300 microns or above.

23. The ultralight flowable material of claim 12, wherein the ultralight flowable material has a specific gravity in a range extending from about 0.02 to about 0.17.

24. An article of manufacture, comprising:
a flexible container; and
an ultralight flowable material contained within the flexible container, wherein the ultralight flowable material comprises:
a plurality of spherical objects comprising microspheres, macrospheres, or a combination thereof; and
a tacky lubricant in an amount to substantially coat the exterior surfaces of essentially all spherical objects but less than an amount to cause dispersion of the spherical objects in the tacky lubricant.

25. The article of manufacture of claim 24, wherein the flexible container is a sealed bladder at least one of a thin plastic film, a fabric laminated to a thin plastic film, and a tight-weave fabric.

26. The article of manufacture of claim 24, wherein the plurality of spherical objects comprises microencapsulated phase change materials; and wherein the tacky lubricant comprises at least one of a mineral oil having a Saybolt viscosity of at least about 70 SUS at 100° F. blended with at least one of an elastomeric polymer and a tackifying agent, a mineral oil having a Saybolt viscosity of about 500 SUS or more at 100° F., and polybutene.

27. The article of manufacture of claim 24, wherein the plurality of spherical objects comprises a plurality of macrospheres, the plurality of macrospheres having an average diameter of at least about 150 microns or above; and wherein the tacky lubricant comprises at least one of a mineral oil having a Saybolt viscosity of at least about 70 SUS at 100° F. blended with at least one of an elastomeric polymer and a tackifying agent, a mineral oil having a Saybolt viscosity of about 500 SUS or more at 100° F., and polybutene.

28. The article of manufacture of claim 24, wherein the plurality of spherical objects comprises a plurality of macrospheres, the plurality of macrospheres having an average diameter of at least about 225 microns or above; and wherein the tacky lubricant comprises at least one of a mineral oil having a Saybolt viscosity of at least about 70 SUS at 100° F. blended with at least one of an elastomeric polymer and a tackifying agent, a mineral oil having a Saybolt viscosity of about 500 SUS or more at 100° F., and polybutene.

29. The article of manufacture of claim 24, wherein the plurality of spherical objects comprises a plurality of macrospheres, the plurality of macrospheres having an average diameter of at least about 300 micron or above; and wherein the tacky lubricant comprises at least one of a mineral oil having a Saybolt viscosity of at least about 70 SUS at 100° F. blended with at least one of an elastomeric polymer and a tackifying agent, a mineral oil having a Saybolt viscosity of about 500 SUS or more at 100° F., and polybutene.
